(19) United States
(12) Patent Application Publication
(10) Pub. No.: US 2026/0288157 A1
(43) Pub. Date: Sep. 24, 2026

(54) CONTROL DEVICE AND CONTROL METHOD

(71) Applicant: HONDA MOTOR CO., LTD., Tokyo (JP)

(72) Inventor: Takaaki Nishida, Wako-shi (JP)

(21) Appl. No.: 19/561,585

(22) Filed: Mar. 10, 2026

(30) Foreign Application Priority Data
Mar. 19, 2025 (JP) 2025-044773

(51) Int. Cl. G05D 1/648; A01D 34/00; A01D 101/00; G05D 107/20

(52) U.S. Cl. CPC G05D 1/648; A01D 34/008; A01D 2101/00; G05D 2107/23

(57) ABSTRACT

A control device is equipped with a turning radius acquisition unit that acquires information indicating a turning radius of a turning operation that is intended to be executed by a working machine on a lawn, a turning radius determination unit which, based on the information that is acquired by the turning radius acquisition unit, determines whether or not the turning radius falls within a predetermined range, and a control correction unit which, in the case that the turning radius falls within the predetermined range, corrects a control command that causes the working machine to execute the turning operation, and thereby to cause the turning radius to deviate from the predetermined range.

### CROSS-REFERENCE TO RELATED APPLICATIONS

This application is based upon and claims the benefit of priority from Japanese Patent Application No. 2025-044773 filed on Mar. 19, 2025, the contents of which are incorporated herein by reference.

### BACKGROUND OF THE INVENTION

### Field of the Invention

The present invention relates to a control device and a control method.

### Description of the Related Art

According to WO 2019/187122 A1, there is disclosed a technique for suppressing the occurrence of slippage in an autonomous traveling working machine.

### SUMMARY OF THE INVENTION

Recently, there has been a long awaited need for a more satisfactory technology in relation to a traveling control for controlling the traveling of a working machine used in carrying out work on a lawn.

The present invention has the object of solving the aforementioned problem.

A first aspect of the present disclosure is characterized by a control device equipped with a turning radius acquisition unit configured to acquire information indicating a turning radius of a turning operation that is intended to be executed by a working machine on a lawn, a turning radius determination unit which, based on the information that is acquired by the turning radius acquisition unit, is configured to determine whether or not the turning radius falls within a predetermined range, and a control correction unit which, in the case that the turning radius falls within the predetermined range, is configured to correct a control command that causes the working machine to execute the turning operation, and thereby to cause the turning radius to deviate from the predetermined range.

A second aspect of the present disclosure is characterized by a control method, the control method comprising a turning radius acquisition step of acquiring information indicating a turning radius of a turning operation that is intended to be executed by a working machine on a lawn, a turning radius determination step of determining, based on the information that is acquired by the turning radius acquisition step, whether or not the turning radius falls within a predetermined range, and a control correction step of correcting, in the case that the turning radius falls within the predetermined range, a control command that causes the working machine to execute the turning operation, and thereby to cause the turning radius to deviate from the predetermined range.

According to the present disclosure, a control device and a control method are provided that are capable of reducing damage that is imparted to a lawn by the turning operation of the working machine.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a view of a working machine according to one embodiment;

FIG. 2 is a block diagram of a control device provided in the working machine shown in FIG. 1;

FIG. 3 is a graph showing an example of a target turning radius of the working machine and a predetermined range;

FIG. 4 is a graph showing a relationship between a traveling velocity of the working machine, an angular velocity of the working machine, and a predetermined range determined in relation to a turning radius of the working machine;

FIG. 5 is a drawing showing a graph (lower portion) illustrating an example of a target turning radius and a predetermined range, and a graph (upper portion) illustrating a point corresponding to the target turning radius and the predetermined range;

FIG. 6 is a drawing showing a graph (lower portion) illustrating an example of a target turning radius and a predetermined range, and a graph (upper portion) illustrating a point corresponding to the target turning radius and the predetermined range;

FIG. 7 is a drawing showing a graph (lower portion) illustrating an example of a target turning radius and a predetermined range, and a graph (upper portion) illustrating a point corresponding to the target turning radius and the predetermined range;

FIG. 8 is a flowchart of a control method according to the embodiment;

FIG. 9 is a flowchart for describing in greater detail a control correction step shown in FIG. 8; and

FIG. 10 is a block diagram of a control device according to Modification 2.

### DETAILED DESCRIPTION OF THE INVENTION

A working machine used for working on a lawn, for example, is an automated lawnmower. Such an automated lawnmower is a lawnmower that carries out lawn mowing work, while autonomously traveling (following a route) along a route that is set in advance in a working area that includes the lawn. Operations that are capable of being carried out by the working machine include a turning operation.

Incidentally, by the turning operation of the working machine on the lawn, there are cases in which damage may be imparted to the lawn. For example, by the turning operation being carried out, tearing up of the grass that is positioned underneath the working machine may occur. In view of this, a technique that is capable of reducing damage from being imparted to the lawn caused by the turning operation of the working machine is desired.

With the above preliminary description in mind, hereinafter, an embodiment of the present invention will be described. Moreover, in the following description, a program (a computer program, computer software) may also be referred to as a computer program product. The computer program product is not limited to being a program that is stored on a storage medium, but may also include a program that is transmitted, distributed, or downloaded via the Internet or the like.

### Embodiments

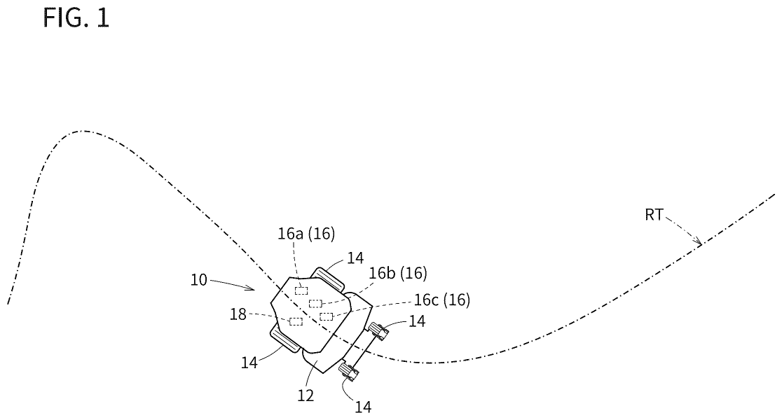

FIG. 1 is a view of a working machine 10 according to an embodiment.

The working machine 10, for example, is a lawnmower such as an automated lawnmower or the like. The working machine 10 may be an unmanned working machine that is capable of autonomous traveling, or may be a manned working machine. A seat such as a steering seat or the like may be provided in the manned working machine. The manned working machine is capable of autonomous traveling, in the same manner as the unmanned working machine. The manned working machine may be steered as necessary by an occupant who is seated in a seat.

The working machine 10 includes a vehicle body 12 that is capable of traveling on grass. A plurality of vehicle wheels 14 are provided on the vehicle body 12. Although illustration thereof is omitted, the vehicle body 12 is further equipped with a drive source such as an internal combustion engine or an electric motor, and a working tool that is used for carrying out predetermined work. The vehicle body 12 travels by means of a driving force that is obtained from a drive source. The working tool, for example, is a cutter for mowing grass.

A plurality of sensors 16 are provided on the vehicle body 12. The plurality of sensors 16 include a vehicle velocity sensor 16a and an angular velocity sensor 16b. The vehicle velocity sensor 16a is a sensor 16 that outputs a detection signal corresponding to the traveling velocity of the working machine 10. The angular velocity sensor 16b is a sensor 16 that outputs a detection signal corresponding to the angular velocity of the working machine 10. Moreover, the angular velocity of the working machine 10 is an amount of change in an orientation of the working machine 10 per unit time.

The plurality of sensors 16 may further include a positioning sensor 16c. The positioning sensor 16c is one of the sensors 16 that serves to detect a position (displacement) of the working machine 10. The positioning sensor 16c may include a receiving device that receives positioning results (positioning signals) of the working machine 10 by a positioning system such as a satellite positioning system or the like.

The working machine 10 is equipped with a control device 18. The control device 18 is an electronic device that controls the vehicle body 12. For example, a computer such as an ECU (Electronic Control Unit) or the like is included in the control device 18.

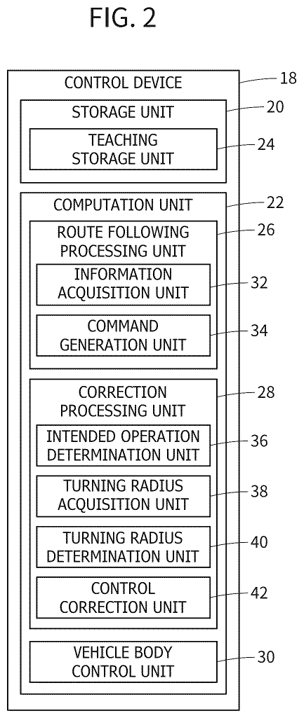

FIG. 2 is a block diagram of the control device 18 provided in the working machine 10 shown in FIG. 1.

The control device 18 is equipped with a storage unit 20, and a computation unit 22.

The storage unit 20 includes at least one memory. The storage unit 20, for example, includes a non-volatile memory such as a ROM (Read Only Memory), a flash memory, or a magnetic disk or the like. The non-volatile memory is a storage medium that stores in a non-temporary manner programs, tables, maps, or the like. At least a portion of the storage unit 20 may be realized by a storage medium such as a USB (Universal Serial Bus) memory, a memory card, or an optical disk or the like. The storage unit 20 may include a volatile memory such as a RAM (Random Access Memory) or the like.

The storage unit 20 includes a teaching storage unit 24 in which teaching data is stored. Various items of information that are taught to the working machine 10 in advance by a user or the like of the working machine 10 are included in the teaching data. For example, route information are included in the teaching data. The route information is information that indicates a route RT (see FIG. 1) that the working machine 10 is made to follow. This route RT is set in a working area including the lawn.

The computation unit 22 includes a processing circuit (Processing Circuitry) that is capable of executing arithmetic processing. The processing circuit may include one or more processors. For example, the processing circuit may include a CPU (Central Processing Unit), a GPU (Graphics Processing Unit), and the like. The processing circuit may include an IC (Integrated Circuit) or may include a discrete device.

The computation unit 22 is equipped with a route following processing unit 26, a correction processing unit 28, and a vehicle body control unit 30. The route following processing unit 26, the correction processing unit 28, and the vehicle body control unit 30 are realized by the aforementioned processing circuit. For example, by the program that is stored in the storage unit 20 being executed by the processor of the computation unit 22, the route following processing unit 26, the correction processing unit 28, and the vehicle body control unit 30 are realized. At least one of the aforementioned IC and the discrete device may realize at least a portion of the route following processing unit 26, the correction processing unit 28, and the vehicle body control unit 30.

The route following processing unit 26 generates a control command in order to realize the route following. More specifically, the route following processing unit 26 generates a control command in order to realize autonomous traveling of the working machine 10 (the vehicle body 12) along the route RT that is indicated by the route information. The route following processing unit 26 comprises an information acquisition unit 32, and a command generation unit 34.

The information acquisition unit 32, based on the detection signals output from the aforementioned plurality of sensors 16, acquires various items of information required in order to generate the control command. For example, the information acquisition unit 32 acquires vehicle velocity information based on a detection signal acquired from the vehicle velocity sensor 16a. The vehicle velocity information is information that indicates a traveling velocity (an estimated traveling velocity) of the working machine 10. Further, for example, the information acquisition unit 32 acquires angular velocity information based on a detection signal acquired from the angular velocity sensor 16b. The angular velocity information is information that indicates an angular velocity (an estimated angular velocity) of the working machine 10. The information acquisition unit 32, based on a detection signal (a positioning signal) acquired from the positioning sensor 16c, acquires position information. The position information is information that indicates a current position (an estimated current position) of the working machine 10.

The command generation unit 34 generates the aforementioned control command based on the various information (the vehicle velocity information, the angular velocity information, the position information, and the like) acquired by the information acquisition unit 32. The control command includes a velocity command and an angular velocity command. The velocity command is a command for controlling a traveling velocity (a target traveling velocity) of the working machine 10. The angular velocity command is a command for controlling an angular velocity (a target angular velocity) of the working machine 10.

The information acquisition unit 32, based on the detection signals that are successively output from each of the plurality of sensors 16, may successively acquire the aforementioned vehicle velocity information, the angular velocity information, the position information, and the like. In that case, the information acquisition unit 32, in accordance with a predetermined control cycle, may sequentially acquire the vehicle velocity information, the angular velocity information, and the position information, and the like. Further, the command generation unit 34, in accordance with the aforementioned predetermined control cycle, may sequentially generate the control command.

The correction processing unit 28 corrects as necessary the control command that is generated by the route following processing unit 26 (the command generation unit 34). More specifically, in the case that there is a possibility, based on the control command, that a turning operation capable of imparting damage to the lawn will be executed, the correction processing unit 28 corrects the control command in order to reduce the damage to the lawn. The correction processing unit 28 comprises an intended operation determination unit 36, a turning radius acquisition unit 38, a turning radius determination unit 40, and a control correction unit 42.

The intended operation determination unit 36 executes an intended operation determination. In the intended operation determination, there is included a process of determining, based on the position information and the route information, whether or not the control command generated by the command generation unit 34 is a command that causes a turning operation to be carried out. Such a process may be a process of determining, based on the position information and the route information, whether or not the working machine 10 has reached a position where the turning operation should be started (prepared).

The turning radius acquisition unit 38 acquires target turning radius information. The target turning radius information is information that indicates a target turning radius TRT. The target turning radius TRT is a turning radius of the turning operation that the working machine 10 is intended to execute on the lawn. Moreover, the turning radius of the working machine 10 can be derived by dividing the traveling velocity of the working machine 10 by the angular velocity of the working machine 10. Accordingly, the target turning radius TRT can be derived by dividing the target traveling velocity by the target angular velocity (target turning radius TRT=target traveling velocity/target angular velocity). Accordingly, the turning radius acquisition unit 38 may acquire, as the target turning radius information, a control command (a velocity command, an angular velocity command) that is determined by the intended operation determination unit 36 to be a command that causes the turning operation to be carried out.

The turning radius determination unit 40 executes a turning radius determination. In the turning radius determination, there is included a process of determining, based on the target turning radius information acquired by the turning radius acquisition unit 38, whether or not the target turning radius TRT falls within a predetermined range RNG.

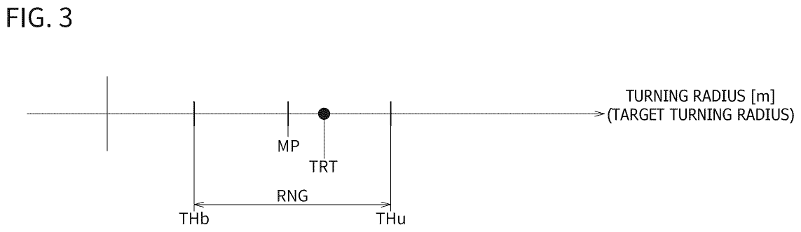

FIG. 3 is a graph showing an example of the target turning radius TRT of the working machine 10 and the predetermined range RNG. Moreover, the midpoint MP shown in FIG. 3 is the midpoint of the predetermined range RNG.

The predetermined range RNG indicates a range of the turning radius that is not permissible from the standpoint of damage that the turning operation of the working machine 10 may impart to the lawn. Stated otherwise, the predetermined range RNG indicates a range of the turning radius that is not satisfactory from the standpoint of damage that the turning operation of the working machine 10 may impart to the lawn. The predetermined range RNG is determined, for example, based on experiments, simulations, or the like that are conducted in advance, in accordance with the configuration (design) of the vehicle body 12. The predetermined range RNG includes, for example, a turning radius of a pivoting turn, in the case that such a pivoting turn is implemented by the working machine 10, although the predetermined range RNG is not necessarily limited to this feature. The predetermined range RNG may include a margin of a certain degree. For example, each of an upper limit THu and a lower limit THb of the predetermined range RNG, which will be described later, may overlap with the range that is acceptable from the aforementioned standpoint. In the present embodiment, a case will be described in which each of the upper limit THu and the lower limit THb of the predetermined range RNG is considered to be acceptable from the aforementioned standpoint.

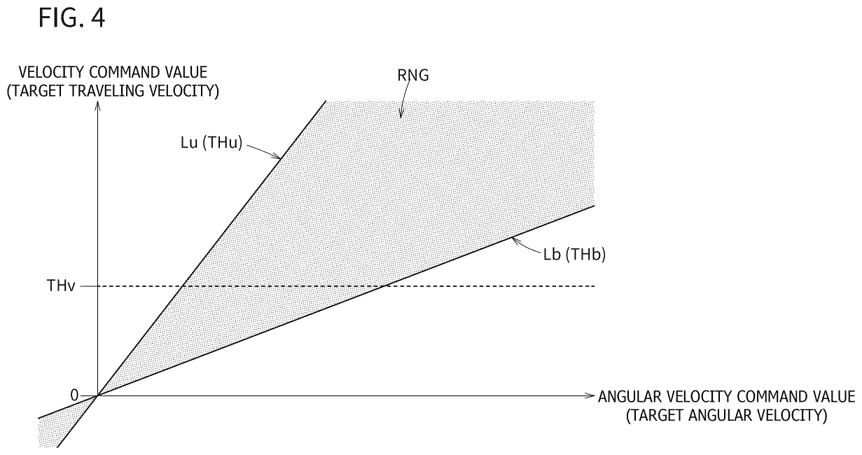

FIG. 4 is a graph showing a relationship between the traveling velocity of the working machine 10, the angular velocity of the working machine 10, and the predetermined range RNG determined in relation to the turning radius of the working machine 10.

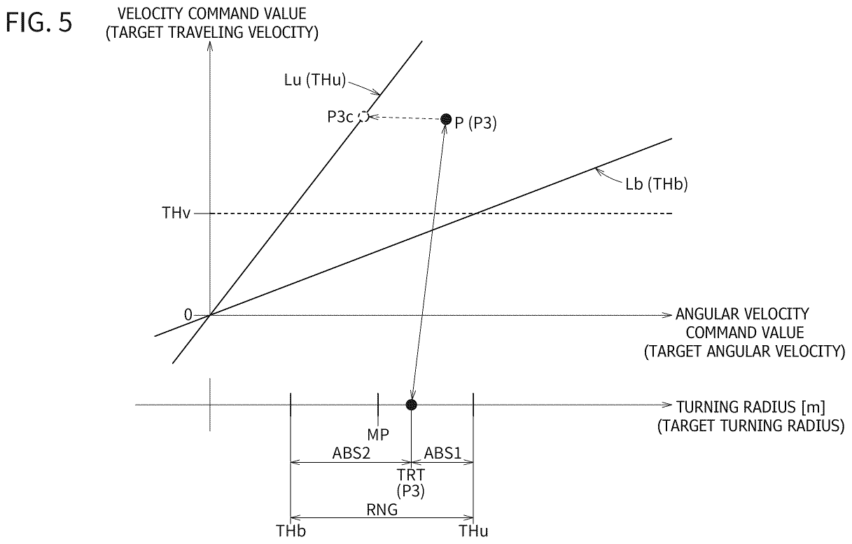

The predetermined range RNG of the turning radius that is determined in accordance with the traveling velocity and the angular velocity, as shown in FIG. 4, can be represented by a plurality of straight lines (Lu, Lb) that are drawn on a graph (a two-axis graph) showing the relationship between the traveling velocity and the angular velocity. The upper limit straight line Lu shown in FIG. 4 is a straight line that indicates the upper limit THu of the predetermined range RNG. The lower limit straight line Lb shown in FIG. 4 is a straight line that indicates the lower limit THb of the predetermined range RNG. The region (the shaded region) surrounded by the upper limit straight line Lu and the lower limit straight line Lb indicates the predetermined range RNG. In the case that a point P, which is plotted in accordance with the target traveling velocity and the target angular velocity on a graph in the form shown in FIG. 4, is included within the shaded region, the target turning radius TRT, which is determined in accordance with the target traveling velocity and the target angular velocity, is included within the predetermined range RNG (refer also to FIG. 5 to FIG. 7). Stated otherwise, in the case that the point P, which is plotted on the graph in the form shown in FIG. 4 (the upper parts of FIG. 5 to FIG. 7), is not included within the area surrounded by the upper limit straight line Lu and the lower limit straight line Lb, the target turning radius TRT corresponding to the point P is included in a preferable range (a satisfactory range) from the aforementioned standpoint.

Moreover, although in FIG. 4, there is primarily shown the first quadrant of the graph, the aforementioned plurality of straight lines (the upper limit straight line Lu and the lower limit straight line Lb) may extend into the third quadrant. Further, a plurality of predetermined ranges RNG may be set, according to a combination of the traveling direction (forward, rearward) of the working machine 10, and the direction of the angular velocity. In that case, although a specific illustration thereof is omitted, for example, an upper limit straight line Lu and a lower limit straight line Lb may be specified that extend across the second quadrant and the fourth quadrant of a graph in the form shown in FIG. 4.

In the case that it is determined by the turning radius determination unit 40 that the target turning radius TRT falls within the predetermined range RNG, the control correction unit 42 corrects the control. In the control correction, there is included a process of correcting the control command that is generated by the route following processing unit 26 (the command generation unit 34), and thereby causing the target turning radius TRT to deviate from the predetermined range RNG. More specifically, in the control correction, there is included a process of causing the target turning radius TRT to deviate from the predetermined range RNG, by correcting at least one of the velocity command (the target driving velocity) and the angular velocity command (the target angular velocity). Moreover, such a process can be restated as a process that causes the point P to move outside of the shaded region, in the case that the point P that is plotted on a graph in the form shown in FIG. 4 based on the control command (the velocity command, the target angular velocity) is included within the shaded region.

The target turning radius TRT, by being corrected to a value that is greater than or equal to the upper limit THu of the predetermined range RNG, or by being corrected to a value that is less than or equal to the lower limit THb of the predetermined range RNG, deviates from the predetermined range RNG. In this regard, the control correction unit 42 acquires (derives) a first absolute difference ABS1 and a second absolute difference ABS2. The first absolute difference ABS1 is an absolute difference between the upper limit THu of the predetermined range RNG and the target turning radius TRT (for example, refer also to FIG. 5). In contrast thereto, the second absolute difference ABS2 is an absolute difference between the lower limit THb of the predetermined range RNG and the target turning radius TRT (for example, refer also to FIG. 5). Depending on the result of the comparison between the first absolute difference ABS1 and the second absolute difference ABS2, the control correction unit 42 may selectively execute a target turning radius increasing process or a target turning radius decreasing process, which will be described hereinafter.

FIG. 5 is a drawing showing a graph (lower portion) illustrating an example of the target turning radius TRT and the predetermined range RNG, and a graph (upper portion) illustrating a point P (point P3) corresponding to the target turning radius TRT and the predetermined range RNG. The form of the graph in the upper portion of FIG. 5 is the same as that shown in FIG. 4. The shading shown in FIG. 4 has been omitted in FIG. 5 for the sake of simplicity. The point P3c in FIG. 5 indicates the target turning radius TRT after correction thereof.

The target turning radius increasing process is a process for increasing the target turning radius TRT to a value that is greater than or equal to the upper limit THu of the predetermined range RNG. In the case that the first absolute difference ABS1 is less than the second absolute difference ABS2 (ABS1<ABS2), the control correction unit 42 preferably executes the target turning radius increasing process. In the case that the first absolute difference ABS1 is less than the second absolute difference ABS2, the target turning radius TRT, as shown in the lower part of FIG. 5, is positioned between the midpoint MP and the upper limit THu of the predetermined range RNG. In this case, by the target turning radius increasing process being executed, the control correction unit 42 is capable of decreasing the amount of change in the target turning radius TRT, as compared to a case in which the target turning radius TRT is decreased to be less than or equal to the lower limit THb of the predetermined range RNG.

As noted previously, by correcting at least one of the velocity command and the angular velocity command, the target turning radius TRT changes. In the case of executing the target turning radius increasing process, the control correction unit 42 may correct only one of the velocity command and the angular velocity command, or may correct both the velocity command and the angular velocity command. However, when executing the target turning radius increasing process, in the case that the velocity command is greater than or equal to a predetermined velocity threshold value THv, the control correction unit 42 preferably corrects the angular velocity command while maintaining the velocity command (refer also to the upper part of FIG. 5). In accordance with this feature, in the case that the traveling velocity (the target traveling velocity) of the working machine 10 is of a certain magnitude, the traveling velocity due to the correction process is prevented from increasing further. As a result, an adverse influence in the accuracy of the route following due to the working machine 10 being excessively accelerated is prevented. Moreover, it should be noted that the predetermined velocity threshold value THv is determined in advance based on experiments, simulations, or the like.

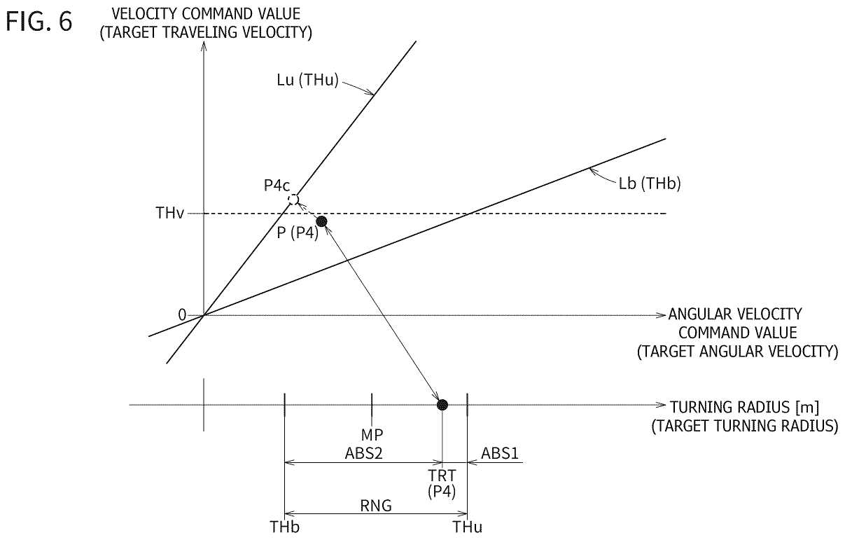

FIG. 6 is a drawing showing a graph (lower portion) illustrating an example of the target turning radius TRT and the predetermined range RNG, and a graph (upper portion) illustrating a point P (point P4) corresponding to the target turning radius TRT and the predetermined range RNG. The form of the graph in the upper portion of FIG. 6 is the same as that of the upper portion shown in FIG. 5. The form of the graph in the lower portion of FIG. 6 is the same as that of the lower portion shown in FIG. 5.

When the target turning radius increasing process is executed, in the case that the velocity command is less than the predetermined velocity threshold value THv, the control correction unit 42 may correct both the velocity command and the angular velocity command. In that case, the control correction unit 42 may correct the velocity command and the angular velocity command, as described in the following paragraphs (i) and (ii), in accordance with whether the product of the velocity command and the angular velocity command is positive or negative.

(i) In the case that the product of the velocity command and the angular velocity command is a positive number, the control correction unit 42 determines the angular velocity command after correction thereof based on Equation (1) and determines the velocity command after correction thereof based on Equation (2). Stated otherwise, in the case that both the velocity command and the angular velocity command are positive numbers, or alternatively, in the case that both the velocity command and the angular velocity command are negative numbers, the control correction unit 42 corrects the velocity command and the angular velocity command based on Equation (1) and Equation (2). Moreover, in relation to each of the equations shown below, ωc is the angular velocity command after correction thereof (the target angular velocity after correction thereof). THu is the upper limit THu of the predetermined range RNG. Vi is the velocity command prior to correction thereof (the target velocity prior to correction thereof). ωi is the angular velocity command prior to correction thereof (the target angular velocity prior to correction thereof). Vc is the velocity command after correction thereof (the target traveling velocity after correction thereof).

$$ω c = ( THu \times Vi + ω i ) / ( {THu}^{2} + 1 ) \qquad ( 1 )$$

$$Vc = THu \times ω c \qquad ( 2 )$$

In the case that the correction process is executed based on the aforementioned Equation (1) and Equation (2), the point P4c, which indicates the target turning radius TRT after correction thereof in the graph in the upper portion of FIG. 6, coincides with the vertical foot of a perpendicular line drawn from point P4 to the upper limit straight line Lu. Accordingly, in the case that the correction process is executed based on the aforementioned Equation (1) and Equation (2), the distance between the point indicating the target turning radius TRT prior to correction thereof and the point indicating the target turning radius TRT after correction thereof is suppressed to a minimum. The distance can be broken down into a velocity command component (a vertical axis component) and an angular velocity command component (a horizontal axis component). The magnitude of the velocity command component corresponds to an amount of correction of the velocity command by the correction process. The magnitude of the angular velocity command component corresponds to an amount of correction of the angular velocity command by the correction process. According to the aforementioned Equation (1) and Equation (2), in the case that the velocity command is less than the predetermined velocity threshold value THv, and further, the target turning radius increasing process is executed, an excessive increase in either one of the amount of correction of the velocity command or the amount of correction of the angular velocity command is suppressed. As a result, the correction process is prevented from adversely influencing the accuracy of the route following.

(ii) In the case that the product of the velocity command and the angular velocity command is a negative number, the control correction unit 42 determines the angular velocity command after correction thereof based on Equation (3) and determines the velocity command after correction thereof based on Equation (4). Stated otherwise, in the case that one of the velocity command and the angular velocity command is a positive number, and the other one thereof is a negative number, the control correction unit 42 corrects the velocity command and the angular velocity command based on Equation (3) and Equation (4). The character symbols included in Equation (3) and Equation (4) are the same as those included in Equation (1).

$$ω c = ( - THu \times Vi + ω i ) / ( {THu}^{2} + 1 ) \qquad ( 3 )$$

$$Vc = - THu \times ω \qquad ( 4 )$$

Also in the case that the correction process is executed based on the aforementioned Equation (3) and Equation (4), the point P4c, which indicates the target turning radius TRT after correction thereof in the graph in the upper portion of FIG. 6, coincides with the vertical foot of a perpendicular line drawn from the point P, which indicates the target turning radius TRT prior to correction thereof, to the upper limit straight line Lu (specific illustration thereof is omitted). Therefore, according to the aforementioned Equation (3) and Equation (4), in the case that the velocity command is less than the predetermined velocity threshold value THv, and further, the target turning radius increasing process is executed, the amount of change in the target turning radius TRT is suppressed to a minimum.

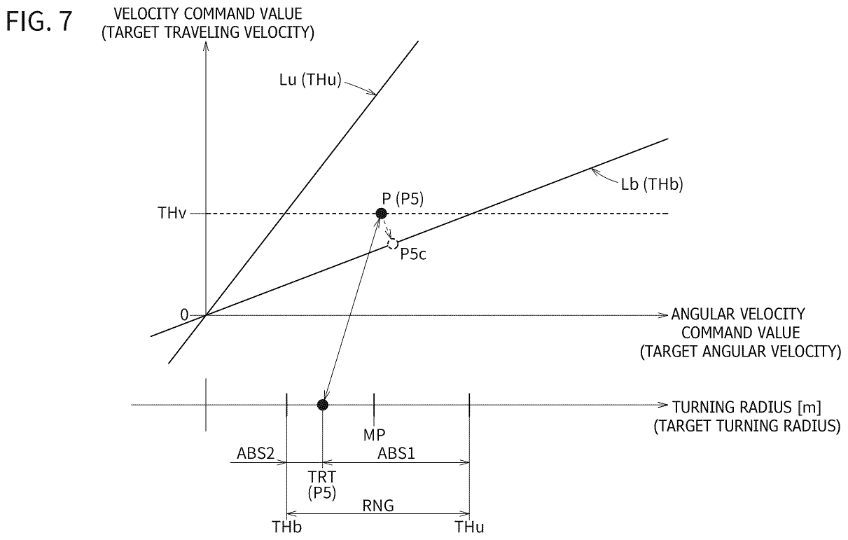

FIG. 7 is a drawing showing a graph (lower portion) illustrating an example of the target turning radius TRT and the predetermined range RNG, and a graph (upper portion) illustrating a point P (point P5) corresponding to the target turning radius TRT and the predetermined range RNG. The form of the graph in the upper portion of FIG. 7 is the same as that of the upper portion shown in FIG. 5. The form of the graph in the lower portion of FIG. 7 is the same as that of the lower portion shown in FIG. 5.

In contrast to the aforementioned target turning radius increasing process, the target turning radius decreasing process is a process for decreasing the target turning radius TRT to a value that is less than or equal to the lower limit THb of the predetermined range RNG. In the case that the second absolute difference ABS2 is less than the first absolute difference ABS1, the control correction unit 42 preferably executes the target turning radius decreasing process. In the case that the second absolute difference ABS2 is less than the first absolute difference ABS1, the target turning radius TRT, as shown in the lower part of FIG. 7, is positioned between the midpoint MP and the lower limit THb of the predetermined range RNG. In this case, by the target turning radius decreasing process being executed, the control correction unit 42 is capable of reducing the amount of change in the target turning radius TRT, as compared to a case in which the target turning radius TRT is increased to be greater than or equal to the upper limit THu of the predetermined range RNG.

In the case that the target turning radius decreasing process is executed, the control correction unit 42 may correct both the velocity command and the angular velocity command. In that case, the control correction unit 42 may correct the velocity command and the angular velocity command as described in the following paragraphs (iii) and (iv), in accordance with whether the product of the velocity command and the angular velocity command is positive or negative.

(iii) In the case that the product of the velocity command and the angular velocity command is a positive number, the control correction unit 42 determines the angular velocity command after correction thereof based on Equation (5) and determines the velocity command after correction thereof based on Equation (6). Stated otherwise, in the case that both the velocity command and the angular velocity command are positive numbers, or alternatively, in the case that both the velocity command and the angular velocity command are negative numbers, the control correction unit 42 corrects the velocity command and the angular velocity command based on Equation (5) and Equation (6). Moreover, in relation to each of the equations shown below, the respective terms ωc, Vi, ωi, and Vc are the same as those in the aforementioned Equation (1). THb is the lower limit THb of the predetermined range RNG.

$$ω c = ( THb \times Vi + ω i ) / ( {THb}^{2} + 1 ) \qquad ( 5 )$$

$$Vc = THb \times ω c \qquad ( 6 )$$

In the case that the correction process is executed based on the aforementioned Equation (5) and Equation (6), the point P5c, which indicates the target turning radius TRT after correction thereof in the graph in the upper portion of FIG. 7, coincides with the vertical foot of a perpendicular line drawn from point P5 to the lower limit straight line Lb. Therefore, according to the aforementioned Equation (5) and Equation (6), in the case that the target turning radius decreasing process is executed, the amount of change in the target turning radius TRT is suppressed to a minimum.

(iv) In the case that the product of the velocity command and the angular velocity command is a negative number, the control correction unit 42 determines the angular velocity command after correction thereof based on Equation (7) and determines the velocity command after correction thereof based on Equation (8). Stated otherwise, in the case that one of the velocity command and the angular velocity command is a positive number, and the other one thereof is a negative number, the control correction unit 42 corrects the velocity command and the angular velocity command based on Equation (7) and Equation (8).

$$ω c = ( - THb \times Vi + ω i ) / ( {THb}^{2} + 1 ) \qquad ( 7 )$$

$$Vc = - THb \times ω c \qquad ( 8 )$$

Also in the case that the correction process is executed based on the aforementioned Equation (7) and Equation (8), the point P5c, which indicates the target turning radius TRT after correction thereof in the graph in the upper portion of FIG. 7, coincides with the vertical foot of a perpendicular line drawn from the point P, which indicates the target turning radius TRT prior to correction thereof, to the lower limit straight line Lb (specific illustration thereof is omitted). Therefore, according to the aforementioned Equation (7) and Equation (8), in the case that the target turning radius decreasing process is executed, the amount of change in the target turning radius TRT is suppressed to a minimum.

Moreover, the control correction unit 42, based on a predetermined priority that is determined beforehand, may select one of the target turning radius increasing process and the target turning radius decreasing process. For example, in the case that the first absolute difference ABS1 and the second absolute difference ABS2 are equal (ABS1=ABS2), the control correction unit 42 may select the process having a higher priority from among the target turning radius increasing process and the target turning radius decreasing process.

The vehicle body control unit 30 controls the vehicle body 12 (the drive source) based on the control command, and thereby causes the working machine 10 to be operated. In the case that the control is corrected by the correction processing unit 28 (the control correction unit 42), the vehicle body control unit 30 controls the vehicle body 12 based on the control command that is corrected.

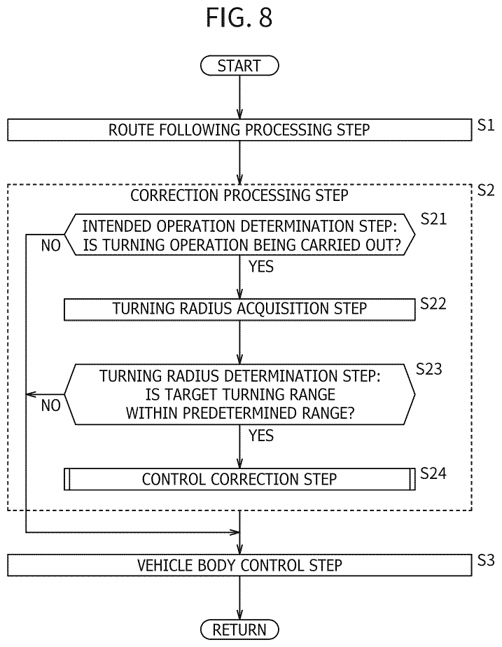

FIG. 8 is a flowchart of the control method according to the embodiment.

The aforementioned control device 18 (computer) is capable of executing the control method shown in FIG. 8. This control method includes a route following processing step S1, a correction processing step S2, and a vehicle body control step S3.

In the route following processing step S1, the route following processing unit 26 generates a control command in order to realize the route following. For example, in the route following processing step S1, based on the various information acquired by the information acquisition unit 32, the command generation unit 34 generates the control command.

After the route following processing step S1, the correction processing step S2 is initiated. In the correction processing step S2, the correction processing unit 28 corrects as necessary the control command that was generated in the route following processing step S1. The correction processing step S2 includes an intended operation determination step S21, a turning radius acquisition step S22, a turning radius determination step S23, and a control correction step S24.

In the intended operation determination step S21, based on the control command that was generated in the route following processing step S1, the intended operation determination unit 36 executes the intended operation determination. As a result thereof, in the case that it is determined that the control command is a command that causes the turning operation to be carried out, the turning radius acquisition step S22 is initiated. On the other hand, in the case that it is determined that the control command is not a command that causes the turning operation to be carried out, the vehicle body control step S3 is initiated.

In the turning radius acquisition step S22, the turning radius acquisition unit 38 acquires the target turning radius information. In the turning radius determination step S23, based on the target turning radius information that was acquired in the turning radius acquisition step S22, the turning radius determination unit 40 executes the turning radius determination. As a result thereof, in the case that it is determined that the target turning radius TRT falls within the predetermined range RNG, the control correction step S24 is initiated. On the other hand, in the case that it is determined that the target turning radius TRT does not fall within the predetermined range RNG (falls within a satisfactory range), the vehicle body control step S3 is initiated.

In the control correction step S24, the control correction unit 42 corrects the control.

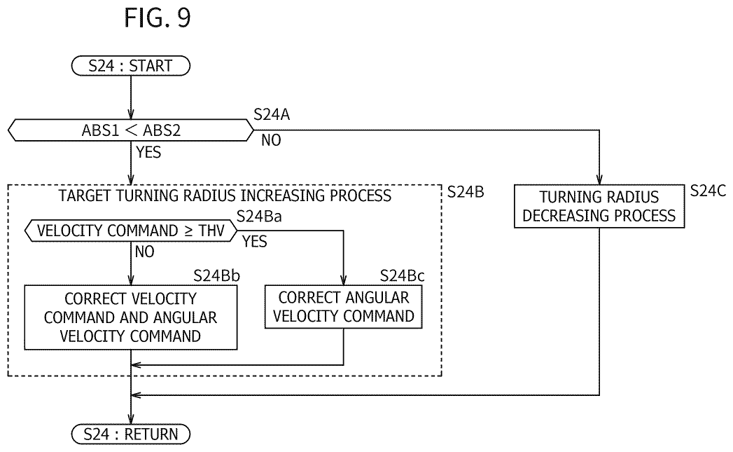

FIG. 9 is a flowchart for describing in greater detail the control correction step shown in FIG. 8.

When the control correction step S24 is initiated, the control correction unit 42 compares the first absolute difference ABS1 and the second absolute difference ABS2 (step S24A). Depending on the result of the comparison, the aforementioned target turning radius increasing process (step S24B), or alternatively, the target turning radius decreasing process (step S24C) is selected. For example, in the case that the first absolute difference ABS1 is less than the second absolute difference ABS2, step S24B is selected. Further, for example, in the case that the second absolute difference ABS2 is less than the first absolute difference ABS1, step S24C is selected.

In the target turning radius increasing process, there is included a process in which the control correction unit 42 determines whether or not the velocity command (the target traveling velocity) is greater than or equal to the predetermined velocity threshold value THv (step S24Ba). In the case that the velocity command is less than the predetermined velocity threshold value THv, the control correction unit 42 may correct both the velocity command and the angular velocity command (step S24Bb). In the case that the velocity command is greater than or equal to the predetermined velocity threshold value THv, from among the velocity command and the angular velocity command, the control correction unit 42 corrects only the angular velocity command (step S24Bc).

In the case that the control correction step S24 is completed, the vehicle body control step S3 is initiated.

In the vehicle body control step S3, the vehicle body control unit 30 controls the vehicle body 12 based on the control command. In this manner, the control method shown in FIG. 8 comes to an end. Moreover, the control method shown in FIG. 8 may be repeatedly executed according to the aforementioned control cycle.

The aforementioned control device 18 (control method), for example, realizes the following advantageous effects.

The control device 18 includes the turning radius determination unit 40 and the control correction unit 42. The turning radius determination unit 40 determines whether or not the turning radius (the target turning radius TRT) of the turning operation that the working machine 10 is intended to execute on the lawn falls within the predetermined range RNG. In the case that the target turning radius TRT falls within the predetermined range RNG, the control correction unit 42 corrects the control command that causes the working machine 10 to execute the turning operation, and thereby to cause the target turning radius TRT to deviate from the predetermined range RNG. In accordance with this feature, the working machine 10 is capable of executing a turning operation that causes relatively little damage to the lawn. As a result thereof, damage that is imparted to the lawn by the turning operation of the working machine 10 is reduced.

In the case that the first absolute difference ABS1 is less than the second absolute difference ABS2, the control correction unit 42 increases the target turning radius TRT. In accordance with such a configuration, the control correction unit 42 is capable of suppressing an increase in the amount of change in the target turning radius TRT.

When the turning radius is increased, in the case that the velocity command is greater than or equal to the predetermined velocity threshold value THv, the control correction unit 42, from among the velocity command and the angular velocity command, corrects the angular velocity command. In this case, it is preferable for the control correction unit 42 to maintain the velocity command without correcting the same. In accordance with such a configuration, an adverse influence in the accuracy of the route following due to the working machine 10 being excessively accelerated is prevented.

In the case that the second absolute difference ABS2 is less than the first absolute difference ABS1, the control correction unit 42 decreases the turning radius. In accordance with such a configuration, the control correction unit 42 is capable of suppressing an increase in the amount of change in the target turning radius TRT.

The embodiment may be modified in the following manner. Moreover, it should be noted that explanations that overlap or are duplicative with those of the embodiment will be appropriately omitted below. The reference numerals used to designate elements and concepts in the embodiment, unless otherwise specified, are also used in the following description.

### Modification 1

In the case that the traveling velocity of the working machine 10 is sufficiently small during the turning operation, there is a strong tendency for the damage to the lawn that is imparted by the turning operation to be suppressed to be relatively small. In consideration of this feature, the intended operation determination unit 36 may determine whether or not the velocity command (the target traveling velocity) that is generated by the route following processing unit 26 is less than a predetermined threshold value in relation to the target traveling velocity. In the case that the velocity command (the target traveling velocity) is less than the threshold value, then regardless of the target turning radius TRT, the correction processing unit 28 need not necessarily correct the control. Moreover, in this case, the threshold value is determined in advance based on experiments, simulations, or the like, in order to distinguish whether or not the velocity command (the target traveling velocity) is sufficiently small. This threshold value may be determined separately from the aforementioned predetermined velocity threshold value THv.

Similarly, in the case that the angular velocity of the working machine 10 is sufficiently small during the turning operation, there is a strong tendency for the damage to the lawn that is imparted by the turning operation to be suppressed to be relatively small. In consideration of this feature, the intended operation determination unit 36 may determine whether or not the angular velocity command (the target angular velocity) that is generated by the route following processing unit 26 is less than a predetermined threshold value in relation to the target angular velocity. In the case that the angular velocity command (the target angular velocity) is less than the threshold value, then regardless of the target turning radius TRT, the correction processing unit 28 need not necessarily correct the control. In this case, the threshold value is determined in advance based on experiments, simulations, or the like, in order to distinguish whether or not the angular velocity command (the target angular velocity) is sufficiently small.

According to the present modification, in the case that at least one of the target traveling velocity and the target angular velocity is sufficiently small, then regardless of the target turning radius TRT, the control is not corrected. As a result, the frequency at which the control command that is generated by the route following processing unit 26 is changed is suppressed. By the frequency at which the control command that is generated by the route following processing unit 26 is changed being suppressed, the route following can be realized more effectively.

### Modification 2

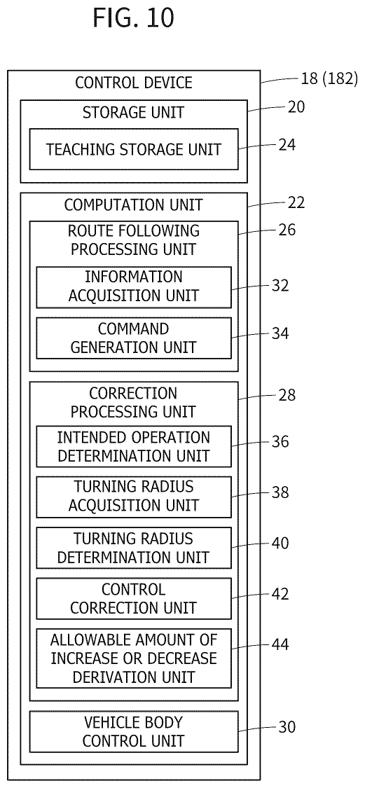

FIG. 10 is a block diagram of the control device 18 (control device 182) according to Modification 2.

The control device 182 differs from the control device 18 of the embodiment (refer also to FIG. 2) at least in that it further is equipped with an allowable amount of increase or decrease derivation unit 44. The allowable amount of increase or decrease derivation unit 44, in the same manner as the route following processing unit 26 and the like, is realized, for example, by the processing circuit of the computation unit 22.

The allowable amount of increase or decrease derivation unit 44 derives the allowable amount of increase or decrease. The allowable amount of increase or decrease is a limit placed on the amount of increase or decrease of the target turning radius TRT, in the case that the target turning radius TRT is changed by the control correction. The allowable amount of increase or decrease is derived based on at least one of the allowable range of the traveling velocity of the working machine 10 and the angular velocity of the working machine 10, and the allowable amount of change per unit time in the turning radius of the working machine 10.

The upper limit of the allowable range of the traveling velocity of the working machine 10, for example, is the upper limit of the traveling velocity in the case that the working machine 10 is traveling forward. The lower limit of the allowable range of the traveling velocity of the working machine 10, for example, is the lower limit of the traveling velocity in the case that the working machine 10 is traveling rearward. Further, the upper limit of the allowable range of the angular velocity of the working machine 10, for example, is the upper limit of the angular velocity in the case that the working machine 10 changes the orientation of the vehicle body 12 along one turning direction. The lower limit of the allowable range of the angular velocity of the working machine 10, for example, is the upper limit of the angular velocity in the case that the working machine 10 changes the orientation of the vehicle body 12 along another turning direction.

The allowable amount of increase or decrease derivation unit 44 limits the range within which the target traveling velocity is capable of being changed in the control correction, in a manner so that the target traveling velocity does not deviate from the allowable range of the traveling velocity. Further, the allowable amount of increase or decrease derivation unit 44 limits the range within which the target angular velocity is capable of being changed in the control correction, in a manner so that the target angular velocity does not deviate from the allowable range of the angular velocity. By the range within which the target traveling velocity is capable of being changed, and the range within which the target angular velocity is capable of being changed being limited, the allowable amount of increase or decrease amount is consequently limited. Moreover, the allowable amount of increase or decrease derivation unit 44 may limit the allowable amount of increase or decrease, by limiting at least one of the range within which the target traveling velocity is capable of being changed and the range within which the target angular velocity is capable of being changed.

The allowable amount of change per unit time in the turning radius of the working machine 10 is a limit placed on the amount of change per unit time in the turning radius of the turning operation that is carried out by the working machine 10. As noted previously, the control command is generated sequentially according to the control cycle (refer to the embodiment). Therefore, the turning radius (the target turning radius TRT) can also be sequentially determined in accordance with the control cycle. The amount of change in the turning radius in a certain control cycle is determined based on the difference between the target turning radius TRT in that one control cycle, and the turning radius in the control cycle immediately prior to that one control cycle.

In the case that the turning radius is changed by the control correction in the one control cycle, the amount of change per unit time in the turning radius specified in that one control cycle changes. More specifically, (a) the difference between the target turning radius TRT prior to correction thereof in the one control cycle, and the turning radius in the control cycle immediately prior thereto, and (b) the difference between the target turning radius TRT after correction thereof in the one control cycle, and the turning radius in the control cycle immediately prior thereto differ from each other. The allowable amount of increase or decrease derivation unit 44 limits the allowable amount of increase or decrease in the one control cycle, in a manner so that the difference described in (b) above does not deviate from the allowable amount of change per unit time in the turning radius.

The allowable range for each of the traveling velocity of the working machine 10 and the angular velocity of the working machine 10, and the allowable amount of change per unit time in the turning radius of the working machine 10 are determined in advance, taking into consideration the standpoint of inhibiting a breakdown in the vehicle body 12, and promoting the riding comfort of the occupant or the like. Based on experiments, simulations, or the like conducted in accordance with such a standpoint, the allowable range for each of the traveling velocity of the working machine 10 and the angular velocity of the working machine 10, and the allowable amount of change per unit time in the turning radius of the working machine 10 may be determined.

The allowable amount of increase or decrease derivation unit 44 may also limit the allowable amount of increase or decrease, based on the allowable range of each of the traveling velocity of the working machine 10 and the angular velocity of the working machine 10, and the allowable amount of change per unit time in the turning radius of the working machine 10. In accordance with this feature, a more satisfactory allowable amount of increase or decrease is specified from the standpoint, for example, of inhibiting a breakdown in the vehicle body 12, and promoting the riding comfort of the occupant or the like.

In the case that the allowable amount of increase or decrease derived by the allowable amount of increase or decrease derivation unit 44 is less than the first absolute difference ABS1, then regardless of the result of the comparison between the first absolute difference ABS1 and the second absolute difference ABS2, the control correction unit 42 may execute the target turning radius decreasing process. The first absolute difference ABS1 is an absolute difference between the upper limit THu of the predetermined range RNG and the target turning radius TRT (in the embodiment). In the case that the allowable amount of increase or decrease is less than this first absolute difference ABS1, then even if the target turning radius TRT is increased to the maximum limit allowed by such an allowable amount of increase or decrease, the target turning radius TRT does not deviate from the predetermined range RNG. In this case, the control correction unit 42, by decreasing the target turning radius TRT, may cause the target turning radius TRT to deviate from the predetermined range RNG.

Further, in the case that the allowable amount of increase or decrease derived by the allowable amount of increase or decrease derivation unit 44 is less than the second absolute difference ABS2, then regardless of the result of the comparison between the first absolute difference ABS1 and the second absolute difference ABS2, the control correction unit 42 may execute the target turning radius increasing process. The second absolute difference ABS2 is an absolute difference between the lower limit THb of the predetermined range RNG and the target turning radius TRT (in the embodiment). In the case that the allowable amount of increase or decrease is less than this second absolute difference ABS2, then even if the target turning radius TRT is decreased to the maximum limit allowed by such an allowable amount of increase or decrease, the target turning radius TRT does not deviate from the predetermined range RNG. In this case, the control correction unit 42, by increasing the target turning radius TRT, may cause the target turning radius TRT to deviate from the predetermined range RNG.

According to the present modification, it is easier for the control correction unit 42 to cause the target turning radius TRT to deviate from the predetermined range RNG while suppressing the amount of change in the target turning radius TRT to be less than or equal to the allowable amount of increase or decrease. More specifically, the allowable amount of increase or decrease derivation unit 44 is capable of causing the control correction unit 42 to correct the control within a range in which there is maintained a satisfactory condition from the standpoint of inhibiting a breakdown of the vehicle body 12, and an adverse influence on the riding comfort of the occupant, or the like. Moreover, from the standpoint of inhibiting a breakdown of the vehicle body 12, and an adverse influence on the riding comfort of the occupant, or the like, the allowable amount of increase or decrease is preferably derived based on an allowable range of each of the traveling velocity of the working machine 10 and the angular velocity of the working machine 10, and an allowable amount of change per unit time in the turning radius of the working machine 10. However, the allowable amount of increase or decrease derivation unit 44 may also limit the allowable amount of increase or decrease, based on at least one of the allowable range of at least one of the traveling velocity of the working machine 10 and the angular velocity of the working machine 10, and the allowable amount of change per unit time in the turning radius of the working machine 10.

### Combination of Plurality of Modifications

The aforementioned plurality of modifications may be combined together as appropriate.

In relation to the aforementioned embodiments, the following Supplementary Notes are further disclosed.

### Supplementary Note 1

The control device (18) according to the present disclosure is equipped with the turning radius acquisition unit (38) that acquires information indicating the turning radius (TRT) of the turning operation that is intended to be executed by the working machine (10) on the lawn, the turning radius determination unit (40) which, based on the information that is acquired by the turning radius acquisition unit, determines whether or not the turning radius falls within the predetermined range (RNG), and the control correction unit (42) which, in the case that the turning radius falls within the predetermined range, corrects the control command that causes the working machine to execute the turning operation, and thereby to cause the turning radius to deviate from the predetermined range. In accordance with such a configuration, damage that is imparted to the lawn by the turning operation of the working machine is reduced.

### Supplementary Note 2

In the control device according to Supplementary Note 1, in the case that the turning radius falls within the predetermined range, and further, the first absolute difference (ABS1), which is the absolute difference between the upper limit of the predetermined range (Thu) and the turning radius, is less than the second absolute difference (ABS2), which is the absolute difference between the lower limit of the predetermined range (THb) and the turning radius, the control correction unit may increase the turning radius. In accordance with such a configuration, the control correction unit is capable of suppressing an increase in the amount of change in the target turning radius.

### Supplementary Note 3

In the control device according to Supplementary Note 2, the control command may include the velocity command for controlling the traveling velocity of the working machine, and the angular velocity command for controlling the angular velocity of the working machine, and in increasing the turning radius increases, in the case that the velocity command is greater than or equal to the predetermined velocity threshold value (THv), the control correction unit may correct the angular velocity command. In accordance with such a configuration, an adverse influence in the accuracy of the route following due to the working machine being excessively accelerated is prevented.

### Supplementary Note 4

In the control device according to Supplementary Note 2, the control command may include the velocity command for controlling the traveling velocity of the working machine, and the angular velocity command for controlling the angular velocity of the working machine, there may further be provided the allowable amount of increase or decrease derivation unit (44) which, based on at least one of the allowable range of at least one of the traveling velocity and the angular velocity, and the allowable amount of change per unit time in the turning radius, may derive the allowable amount of increase or decrease in the turning radius that is to be changed, and in the case that the allowable amount of increase or decrease is less than the first absolute difference, then regardless of the first absolute difference and the second absolute difference, the control correction unit may decrease the turning radius. In accordance with such a configuration, it is easier for the control correction unit to cause the target turning radius to deviate from the predetermined range while suppressing the amount of change in the target turning radius to be less than or equal to the allowable amount of increase or decrease.

### Supplementary Note 5

In the control device according to any one of Supplementary Notes 1 to 4, in the case that the turning radius falls within the predetermined range, and further, the second absolute difference (ABS2), which is the absolute difference between the lower limit of the predetermined range (THb) and the turning radius, is less than the first absolute difference (ABS1), which is the absolute difference between the upper limit of the predetermined range (THu) and the turning radius, the control correction unit may decrease the turning radius. In accordance with such a configuration, the control correction unit is capable of suppressing an increase in the amount of change in the target turning radius.

### Supplementary Note 6

In the control device according to Supplementary Note 5, the control command may include the velocity command for controlling the traveling velocity of the working machine, and the angular velocity command for controlling the angular velocity of the working machine, there may further be provided the allowable amount of increase or decrease derivation unit (44) which, based on at least one of the allowable range of at least one of the traveling velocity and the angular velocity, and the allowable amount of change per unit time in the turning radius, may derive the allowable amount of increase or decrease in the turning radius that is to be changed, and in the case that the allowable amount of increase or decrease is less than the second absolute difference, then regardless of the first absolute difference and the second absolute difference, the control correction unit may increase the turning radius. In accordance with such a configuration, it is easier for the control correction unit to cause the target turning radius to deviate from the predetermined range while suppressing the amount of change in the target turning radius to be less than or equal to the allowable amount of increase or decrease.

### Supplementary Note 7

The control method according to the present disclosure comprises the turning radius acquisition step (S22) of acquiring information indicating the turning radius (TRT) of the turning operation that is intended to be executed by the working machine (10) on the lawn, the turning radius determination step (S23) of determining, based on the information that is acquired by the turning radius acquisition step, whether or not the turning radius falls within the predetermined range (RNG), and the control correction step (S24) of correcting, in the case that the turning radius falls within the predetermined range, the control command that causes the working machine to execute the turning operation, and thereby to cause the turning radius to deviate from the predetermined range.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the aforementioned embodiments, the order of each of the operations and the order of each of the processes are illustrated as examples, and the present invention is not necessarily limited to these features. The same also applies to cases in which numerical values or mathematical expressions are used in the description of the aforementioned embodiments.

What is claimed is:

1. A control device comprising one or more processors that execute computer-executable instructions stored in a memory, wherein the one or more processors execute the computer-executable instructions to cause the control device to:
acquire information indicating a turning radius of a turning operation to be executed by a working machine on a lawn;
based on the information that is acquired, determine whether or not the turning radius falls within a predetermined range;
in the case that the turning radius falls within the predetermined range, correct a control command that causes the working machine to execute the turning operation to cause the turning radius to deviate from the predetermined range.

2. The control device according to claim 1, wherein, in the case that the turning radius falls within the predetermined range, and further, a first absolute difference, which is an absolute difference between an upper limit of the predetermined range and the turning radius, is less than a second absolute difference, which is an absolute difference between a lower limit of the predetermined range and the turning radius, the one or more processors cause the control device to increase the turning radius.

3. The control device according to claim 2, wherein:
the control command includes a velocity command for controlling a traveling velocity of the working machine, and an angular velocity command for controlling an angular velocity of the working machine; and
in increasing the turning radius, in a case that the velocity command is greater than or equal to a predetermined velocity threshold value, the one or more processors cause the control device to correct the angular velocity command.

4. The control device according to claim 2, wherein:
the control command includes a velocity command for controlling a traveling velocity of the working machine, and an angular velocity command for controlling an angular velocity of the working machine;
the one or more processors cause the control device to:
based on at least one of an allowable range of at least one of the traveling velocity and the angular velocity, and an allowable amount of change per unit time in the turning radius, derive an allowable amount of increase or decrease in the turning radius that is to be changed; and
in the case that the allowable amount of increase or decrease is less than the first absolute difference, then regardless of the first absolute difference and the second absolute difference, decrease the turning radius.

5. The control device according to claim 1, wherein, in the case that the turning radius falls within the predetermined range, and further, a second absolute difference, which is an absolute difference between a lower limit of the predetermined range and the turning radius, is less than a first absolute difference, which is an absolute difference between an upper limit of the predetermined range and the turning radius, the one or more processors cause the control device to decrease the turning radius.

6. The control device according to claim 5, wherein:
the control command includes a velocity command for controlling a traveling velocity of the working machine, and an angular velocity command for controlling an angular velocity of the working machine;
the one or more processors cause the control device to:
based on at least one of an allowable range of at least one of the traveling velocity and the angular velocity, and an allowable amount of change per unit time in the turning radius, derive an allowable amount of increase or decrease in the turning radius that is to be changed; and
in the case that the allowable amount of increase or decrease is less than the second absolute difference, then regardless of the first absolute difference and the second absolute difference, causes the control device to increase the turning radius.

7. A control method configured to be executed by one or more processors, comprising:
acquiring information indicating a turning radius of a turning operation to be executed by a working machine on a lawn;
based on the information that is acquired, determining whether or not the turning radius falls within a predetermined range; and
in the case that the turning radius falls within the predetermined range, correcting a control command that causes the working machine to execute the turning operation to cause the turning radius to deviate from the predetermined range.
